(19) United States
(12) Patent Application Publication
(10) Pub. No.: US 2026/0057554 A1
(43) Pub. Date: Feb. 26, 2026

(54) SYSTEM AND METHOD OF IMAGE-TO-IMAGE TRANSLATION IN DIFFUSION SEED SPACE

(71) Applicant: GM Global Technology Operations LLC, Detroit, MI (US)

(72) Inventors: Or Greenberg, Pardes Hanna-Karkur (IL); Eran Kishon, Hod Hasharon (IL); Daniel Lischinski, Jerusalem (IL)

(73) Assignees: GM Global Technology Operations LLC, Detroit, MI (US); Yissum Research Development Company of the Hebrew University of Jerusalem Ltd., Jerusalem (IL)

(21) Appl. No.: 18/810,874

(22) Filed: Aug. 21, 2024

(51) Int. Cl. G06T 9/00; G06T 5/70

(52) U.S. Cl. CPC G06T 9/00; G06T 5/70

(57) ABSTRACT

A computer-implemented method of image-to-image translation that, when executed by data processing hardware, causes the data processing hardware to perform operations comprising applying an inversion technique to an input image to generate a source-domain seed, translating the source-domain seed to a target-domain seed using a translation module, and sampling the target-domain seed to generate a denoised code.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates generally to image manipulation and, more particularly, a method of unpaired image-to-image translation.

Image-to-Image Translation (I2IT) is a family of algorithms used to modify specific attributes (i.e., translation) of an image. It is often used to augment datasets used for training algorithms (e.g., perception for automotive applications). Diffusion Models (DMs) were recently found to be a scheme for generating controlled images. However, modifying specific attributes without changing other semantic and appearance aspects remains challenging. Shortcomings of existing systems and methods are addressed by one or more aspects of the present disclosure.

### SUMMARY

In one configuration, a computer-implemented method of image-to-image translation that, when executed by data processing hardware, causes the data processing hardware to perform operations is provided. The operations include applying an inversion technique to an input image to generate a source-domain seed, translating the source-domain seed to a target-domain seed using a translation module, and sampling the target-domain seed to generate a denoised code.

The method may include one or more of the following optional aspects or steps. For example, that method can further include encoding the input image to a latent space to generate an encoded input image and decoding the denoised code to generate a translated image.

According to at least one aspect, encoding the input image can further include applying a stable diffusion model to the input image.

According to another aspect, applying the inversion technique to the encoded input image to generate the source-domain seed can further include applying a denoising diffusion implicit model (DDIM) inversion to the input image.

According to at least one example, decoding the denoised code can further include generating code of the translated image that includes a global appearance effect or removes a global appearance effect.

According to another example, the method can further include applying a spatial guidance module to maintain structural similarity between the input image and the translated image.

According to at least one aspect, translating the source-domain seed can further include applying a seed-to-seed generative adversarial network (sts-GAN).

According to another aspect, sampling the target-domain seed can further include preserving semantic and structure details of the input image.

According to at least one example, sampling the target-domain seed can further include applying a pre-trained stable diffusion model with a target output prompt.

In another configuration, a system for image-to-image translation in a diffusion seed space for generating perception data for a perception system of a vehicle is provided and includes data processing hardware and memory hardware in communication with the data processing hardware, the memory hardware storing instructions that, when executed on the data processing hardware, cause the data processing hardware to perform operations. The operations include encoding an input image to a stable diffusion latent space to generate an encoded input image, applying a denoising diffusion implicit model (DDIM) inversion to the encoded input image to generate a source-domain seed, translating the source-domain seed to a target-domain seed using a translation module, sampling the target-domain seed to generate a denoised code, and decoding the denoised code to generate a translated image.

The system may include one or more of the following optional aspects or steps. For example, encoding the input image further includes applying a stable diffusion model to the input image.

According to at least one aspect, applying the denoising diffusion implicit model (DDIM) inversion to the input image further includes receiving a source input prompt.

According to another aspect, translating the source-domain seed includes applying a seed-to-seed generative adversarial network (sts-GAN).

According to at least one example, sampling the target-domain seed further includes preserving semantic and structure details of the input image.

According to another example, sampling the target-domain seed further includes applying a pre-trained stable diffusion model with a target output prompt. Applying the pre-trained stable diffusion model can further include identifying a relationship between the source-domain seed and the target-domain seed.

According to at least one aspect, decoding the denoised code further includes generating code of the translated image that includes a global appearance effect. Decoding the denoised code can further include generating code of the translated image that removes a global appearance effect.

According to another aspect, the system further includes applying a spatial guidance module to maintain structural similarity between the input image and the translated image.

### BRIEF DESCRIPTION OF THE DRAWINGS

The drawings described herein are for illustrative purposes only of selected configurations and are not intended to limit the scope of the present disclosure.

FIG. 1 is a front perspective view of a vehicle according to principles of the present disclosure;

FIG. 2 is a schematic diagram of a computing system according to the principles of the present disclosure;

FIG. 3 is a schematic block diagram of a diffusion model according to principles of the present disclosure; and

FIG. 4 is a flow diagram depicting a method of image-to-image translation using the diffusion model of FIG. 3.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms “first,” “second,” “third,” etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

In this application, including the definitions below, the term “module” may be replaced with the term “circuit.” The term “module” may refer to, be part of, or include an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor (shared, dedicated, or group) that executes code; memory (shared, dedicated, or group) that stores code executed by a processor; other suitable hardware components that provide the described functionality; or a combination of some or all of the above, such as in a system-on-chip.

The term “code,” as used above, may include software, firmware, and/or microcode, and may refer to programs, routines, functions, classes, and/or objects. The term “shared processor” encompasses a single processor that executes some or all code from multiple modules. The term “group processor” encompasses a processor that, in combination with additional processors, executes some or all code from one or more modules. The term “shared memory” encompasses a single memory that stores some or all code from multiple modules. The term “group memory” encompasses a memory that, in combination with additional memories, stores some or all code from one or more modules. The term “memory” may be a subset of the term “computer-readable medium.” The term “computer-readable medium” does not encompass transitory electrical and electromagnetic signals propagating through a medium, and may therefore be considered tangible and non-transitory memory. Non-limiting examples of a non-transitory memory include a tangible computer readable medium including a nonvolatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described herein can be realized in digital electronic and/or optical circuitry, integrated circuitry, specially designed ASICS (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a key board and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

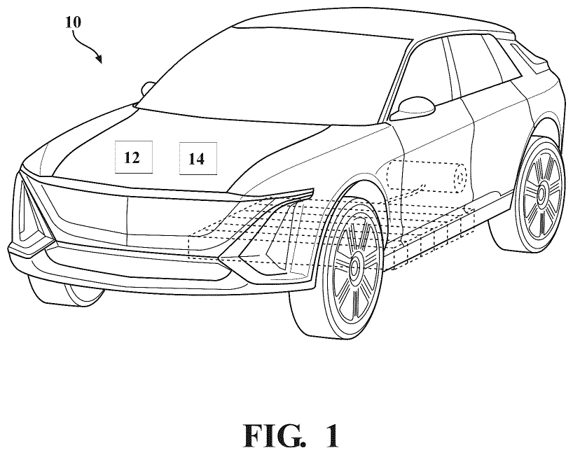

With reference to FIG. 1, a vehicle 10 is provided and can be equipped with various sensors 12 that are configured to gather sensor data concerning an environment surrounding the vehicle 10. The sensor data can be evaluated by a perception system 14 that includes one or more perception detectors. The perception detectors can be trained with annotated data to identify one or more objects in the environment. Collecting the necessary amount of data to properly train perception detectors based on a given vehicle configuration can time consuming. A system and method introduced below can be desirable for training the perception system 14 of the vehicle 10, for example.

Aspects of the present disclosure introduce using a generative adversarial network (GAN) scheme to optimize a latent seed with which a diffusion model (DM) starts its sampling process. More particularly, semantic information encoded within a seed-space of a pre-trained DM can be leveraged to manipulate images. For instance, inverted seeds can be used to discriminate between semantic attributes of images and these attributes can be manipulated to achieve desired transformations in an unpaired image-to-image translation setting. As discussed in more detail below, a seed-to-seed-GAN (sts-GAN) (i.e., an unpaired translation model) can be trained based on CycleGAN or another GAN-based model to translate between source seeds and target seeds. Translated seeds can then be used as an input to the DM's sampling process and provide a final translated image.

As discussed in detail below, the sts-GAN is provided and operated in a seed space of a pre-trained diffusion model (DM). For any source image, there is a target image (i.e., manipulated image) and a corresponding seed. If a deterministic DM scheme is used (e.g., denoising diffusion implicit model (DDIM)), the sampling process will deterministically lead to the required target image. Associating a seed with a target image can be accomplished using the pre-trained DM.

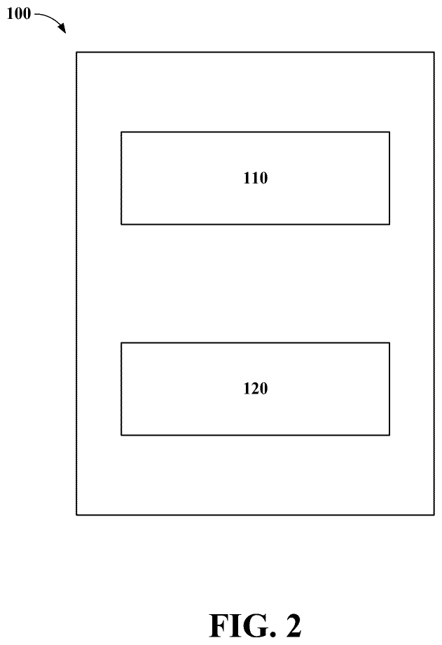

With reference to FIG. 2, a computing system 100 is provided and includes data processing hardware 110 and memory hardware 120 in communication with the data processing hardware 110. The memory hardware 120 is configured to store instructions that, when executed on the data processing hardware 110 cause the data processing hardware 110 to perform operations. The data processing hardware 110 may be embodied as a discrete microprocessor, an application specific integrated circuit (ASIC), or a dedicated control module. Additionally or alternatively, the computing system 100 can include a central processing unit (CPU) 110 that is coupled to memory hardware 120 each of which may take on the form of a CD-ROM, magnetic disk, IC device, semiconductor memory (e.g., various types of RAM or ROM), etc., and/or a real-time clock (RTC). In other examples, the computing system 100 can include more or less components than what is provided in the present illustrative example.

The memory hardware 120 can be configured to include a diffusion model 200, such as a deterministic denoising diffusion implicit model (DDIM) process that provides generalization for deterministic sampling. The DDIM process is desirable for inversion, which makes it possible to map images back to a seed-space. Inversion can be desirable for editing real images using pre-trained diffusion models. According to one aspect, the deterministic DDIM process can be used to denoise a sample xₜ to yield a subsequent step xₜ₋₁. This can be represented by equation (I):

$${x}_{t - 1} = \sqrt{{α}_{t - 1}} \cdot {\hat{x}}_{0} + \sqrt{1 - {α}_{t - 1}} \cdot {∈}_{θ}^{t} ( {x}_{t} ) \qquad ( I )$$

\hat{x}₀ is a prediction of a final denoised sample x₀ from xₜ, which can be represented by equation (II):

$${\hat{x}}_{0} = \frac{{x}_{t} - \sqrt{1 - {α}_{t}} \cdot {∈}^{t} θ ( {x}_{t} )}{\sqrt{{α}_{t}}} \qquad ( II )$$

αₜ₋₁, αₜ are per-timestep diffusion hyperparameters, and

$${∈}_{θ}^{t}$$

is a noise prediction U-net parameterized by θ.

A reverse process, referred to as DDIM inversion, can be represented by equation (III):

$${x}_{t + 1} = \sqrt{{α}_{t + 1}} \cdot {\hat{x}}_{0} + \sqrt{1 - {α}_{t + 1}} \cdot {∈}_{θ}^{t} ( {x}_{t} ) \qquad ( III )$$

Classifier-free guidance (CFG) can be used to adapt the deterministic DDIM process to text-guided generation. With CFG, an unconditioned prediction can be extrapolated with a conditioned prediction using a pre-defined guidance scale factor ω. This can be represented by equation (IV):

$${∈}_{θ}^{t} ( {x}_{t} , C , ϕ ) = ω \cdot {∈}_{θ}^{t} ( {x}_{t} , C ) + ( 1 - ω ) \cdot {∈}_{θ}^{t} ( {x}_{t} , ϕ ) \qquad ( IV )$$

C may be referred to as a condition prompt and ϕ may be referred to as a null prompt (i.e., “”).

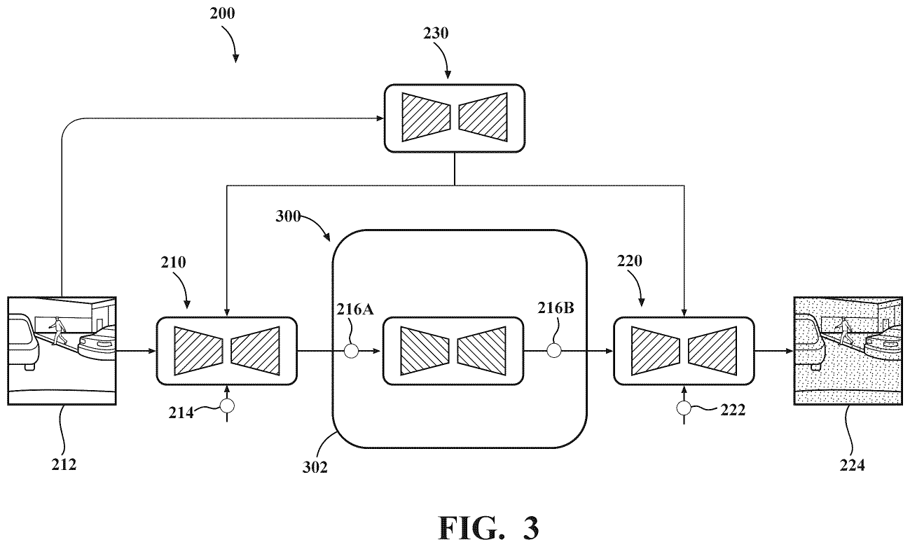

With reference to FIG. 3, a block diagram of the diffusion model 200 is provided. The diffusion model 200 can include an inversion module 210, a sampling module 220, a spatial guidance module 230 in communication with the inversion module 210 and the sampling module 220, and a translation module 300 in communication with the inversion module 210 and the sampling module 220. As will be discussed in more detail below, the translation module 300 can include a seed-space 302 that contains elements of n-dimensional tensors (e.g., 4×64×64) of approximately uncorrelated normally distributed variables.

The inversion module 210 can be configured with a pre-trained stable diffusion model. The inversion module 210 can be further configured to receive an input or source image 212 as well as a source input prompt (i.e., a source-domain referred prompt) 214 and provide DDIM-inverted seeds 216 from a source domain 216A and a target domain 216B based on the input image 212 and the source input prompt 214. According to one aspect, the inversion module 210 can be configured with CFG-scale ω=1. In general, the inversion module 210 can be desirable for mapping from input images 212 to latent codes in the seed-space 302.

The sampling module 220 module can be configured for injective mapping between the space of seeds (i.e., the seed-space 302) and the space of images. In general, the sampling module 220 can be configured to receive the target-domain seed 216B and a target output prompt (i.e., a target-domain referred prompt) 222 and provide denoised code that can be decoded to produce a translated image (i.e., target image) 224. According to one aspect, the sampling module 220 can be configured with the same pre-trained stable diffusion model as the inversion module 210. For DDIM sampling, a CFG-scale ω>1 can be used.

The translation module 300 can be configured to utilize seeds (e.g., the source-domain seed 216A and the target-domain seed 216B) resulting from the inversion module 210 and manipulate the information encoded in the seed-space 302 before undergoing the denoising process within the sampling module 220. In the present illustrative example, the translation module 300 can be configured with a translation model (i.e., seed-to-seed GAN (sts-GAN)) 310 that is configured to learn a mapping between seeds in the source domain 216A and the target domain 216B. A CycleGAN architecture and training strategy can be used to train the translation with the seed from the source domain 216A and the target domain 216B. A CFG-scale ω=1 can be used to invert unpaired source and target domain images to the seed space using stable diffusion, for example. In other words, the translation module 300 can be configured to identify the most accurate seed possible within the seed space 302 and provide it to the sampling module 220 to ensure that the translated image 224 complies with the target domain while preserving the semantic and structure details of the input image 212.

The spatial guidance module 230 can be configured to ensure structural similarity between the input image 212 and the translated image 224. The spatial guidance module 230 can be configured with a spatial guidance mechanism, such as ControlNet, for example. The spatial guidance mechanism can be used for conditionally guided control sampling to preserve the structure and semantics of the input image, for example.

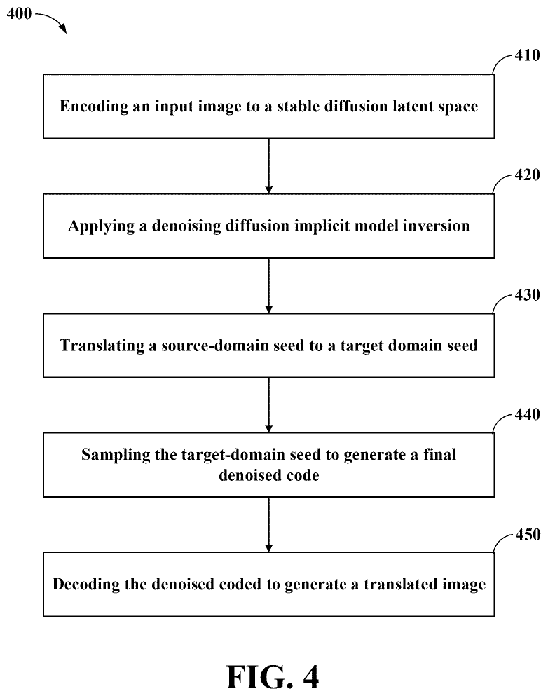

With reference to FIG. 4, a computer-implemented method 400 of image-to-image translation that, when executed by data processing hardware, causes the data processing hardware to perform operations. The operations are outlined as follows.

At 410, the input image 212 can be encoded to a latent space using a diffusion model that has n-dimensional (e.g., 4×64×64) tensors of approximately uncorrelated normal distributed variables. In other words, stable diffusion can be used to generate an encoded input image in a stable diffusion latent space. In general, the stable diffusion latent space refers to a latent representation that wraps the diffusion process. The latent representation can be generated by a variational auto-encoder (e.g., based on VQ-GAN) that is used when receiving the input image 212 and when generating the translated image 224. According to one aspect, stable diffusion includes the auto-encoder and the diffusion model (i.e., a UNET-based neural network applied iteratively).

At 420, an inversion technique, such as DDIM inversion, and the source input prompt (i.e., source domain-referred prompt) 214 can be applied to the encoded image to obtain a corresponding source-domain seed 216A (i.e., a stable diffusion seed).

At 430, the source-domain seed 216A is translated to a target-domain seed 216B using the translation module 300 (i.e., the sts-GAN).

At 440, the target-domain seed 216B is sampled using the pre-trained stable diffusion model with an input prompt (i.e., a target-domain referred prompt) to provide a denoised code, for example. The sampling module 220 can be configured so that semantic and structure details of the input image are preserved during sampling.

At 450, the denoised code is decoded and the translated image (i.e., the target image) 224 is provided.

According to at least one aspect of the method 400, the variational auto-encoder can be configured to decode denoised. In other words, the variational auto-encoder can receive denoised code (i.e., output of the DM sampling process within the latent space) and decode it to the image space. Denoising the code can include generating code that provides the translated image 224 with a global appearance effect (e.g., clear night to rainy night, clear night to foggy night, clear day to rainy day, clear night to foggy night, etc.). Additionally or alternatively, denoising the code can include generating code that provides the translated image 224 without the global appearance effect (e.g., rainy night to clear night, foggy night to clear night, rainy day to clear day, foggy night to clear night, etc.).

In another configuration, the method 400 can include another step where the spatial guidance module 230 receives the input image 212 and is configured to supplement the inversion module 210 and the sampling module 220 to maintain structural similarity between the input image 212 and the translated image 224.

A number of implementations have been described. Nevertheless, it will be understood that various modifications may be made without departing from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A computer-implemented method of image-to-image translation that, when executed by data processing hardware, causes the data processing hardware to perform operations comprising:
applying an inversion technique to an input image to generate a source-domain seed;
translating the source-domain seed to a target-domain seed using a translation module; and
sampling the target-domain seed to generate a denoised code.

2. The method of claim 1, further comprising:
encoding the input image to a latent space to generate an encoded input image; and
decoding the denoised code to generate a translated image.

3. The method of claim 2, wherein encoding the input image further comprises applying a stable diffusion model to the input image.

4. The method of claim 2, wherein applying the inversion technique to the encoded input image to generate the source-domain seed further includes applying a denoising diffusion implicit model (DDIM) inversion to the encoded input image.

5. The method of claim 2, wherein decoding the denoised code further includes generating code of the translated image that includes a global appearance effect or removes a global appearance effect.

6. The method of claim 2, further comprising applying a spatial guidance module to maintain structural similarity between the input image and the translated image.

7. The method of claim 1, wherein translating the source-domain seed includes applying a seed-to-seed generative adversarial network (sts-GAN).

8. The method of claim 1, wherein sampling the target-domain seed further comprises preserving semantic and structure details of the input image.

9. The method of claim 1, wherein sampling the target-domain seed further comprises applying a pre-trained stable diffusion model with a target output prompt.

10. The method of claim 9, wherein applying the pre-trained stable diffusion model further comprises identifying a relationship between the source-domain seed and the target-domain seed.

11. A system for image-to-image translation in a diffusion seed space for generating perception data for a perception system of a vehicle, comprising:
data processing hardware; and
memory hardware in communication with the data processing hardware, the memory hardware storing instructions that, when executed on the data processing hardware, cause the data processing hardware to perform operations comprising:
encoding an input image to a stable diffusion latent space to generate an encoded input image;
applying a denoising diffusion implicit model (DDIM) inversion to the encoded input image to generate a source-domain seed;
translating the source-domain seed to a target-domain seed using a translation module;
sampling the target-domain seed to generate a denoised code; and
decoding the denoised code to generate a translated image.

12. The system of claim 11, wherein encoding the input image further comprises applying a stable diffusion model to the input image.

13. The system of claim 11, wherein applying the denoising diffusion implicit model inversion to the input image further comprises receiving a source input prompt.

14. The system of claim 11, wherein translating the source-domain seed includes applying a seed-to-seed generative adversarial network (sts-GAN).

15. The system of claim 11, wherein sampling the target-domain seed further comprises preserving semantic and structure details of the input image.

16. The system of claim 11, wherein sampling the target-domain seed further comprises applying a pre-trained stable diffusion model with a target output prompt.

17. The system of claim 16, wherein applying the pre-trained stable diffusion model further comprises identifying a relationship between the source-domain seed and the target-domain seed.

18. The system of claim 11, wherein decoding the denoised code further includes generating code of the translated image that includes a global appearance effect.

19. The system of claim 18, wherein decoding the denoised code further includes generating code of the translated image that removes a global appearance effect.

20. The system of claim 11, further comprising applying a spatial guidance module to maintain structural similarity between the input image and the translated image.
